(19) United States
(12) Patent Application Publication
(10) Pub. No.: US 2009/0203371 A1
(43) Pub. Date: Aug. 13, 2009

(54) DEVICE, SYSTEM AND METHOD FOR SELECTING NUMBER AND OPENING ACCOUNT FOR PREPAID SUBSCRIBER

(75) Inventors: Jinwen Sheng, Shenzhen (CN); Hanqiang Fu, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/429,000

(22) Filed: Apr. 23, 2009

Related U.S. Application Data
(63) Continuation of application No. PCT/CN2008/070405, filed on Mar. 4, 2008.

(30) Foreign Application Priority Data
Mar. 23, 2007 (CN) 200710087200.5

(51) Int. Cl. H04M 17/00; H04M 3/00; G06Q 10/00; G06Q 50/00

(52) U.S. Cl. 455/418

(57) ABSTRACT

A system, device and method for selecting numbers and opening accounts for prepaid subscribers are disclosed. The system includes at least one device for selecting numbers and opening accounts for prepaid subscribers and at least one terminal for selecting numbers and opening accounts for prepaid subscribers. The technical solution of the present invention separates the International Mobile Subscriber Identity (IMSI) from the Mobile Station International Integrated Services Digital Network Number (MSISDN); a prepaid subscriber selects a number and opens an account through a terminal and device for selecting numbers and opening accounts; the device for selecting numbers and opening accounts opens an account for the subscriber only after the subscriber selects an MSISDN, and registers the subscriber data with the relevant network entities, thus reducing occupation of equipment resources and costs of network operation and improving equipment performance.

### CROSS-REFERENCE TO RELATED APPLICATIONS

This application is a continuation of International Application No. PCT/CN2008/070405, filed on Mar. 4, 2008, which claims the benefit of Chinese Patent Application No. 200710087200.5, filed on Mar. 23, 2007, both of which are hereby incorporated by reference in their entireties.

### FIELD OF THE INVENTION

The present invention relates to mobile communication technologies, and in particular, to a device, terminal, system and method for selecting numbers and opening accounts for prepaid subscribers in a mobile communication network.

### BACKGROUND OF THE INVENTION

A prepaid subscriber needs to purchase a subscriber card such as a Subscriber Identity Module (SIM) or a removable User Identity Module (UIM) card from an operator before being able to access and use the mobile communication network of the operator.

The SIM card is applicable to a Global System for Mobile Communications (GSM). A GSM subscriber needs to insert a SIM card into a terminal device before being able to use the mobile network. The SIM card stores a subscriber ID, network parameters, an authentication algorithm, keys, and so on. Through the SIM card, the subscriber accesses the GSM network simply and securely. The prerequisite to the use of the GSM network is that the subscriber has opened an account for a SIM card in the GSM network.

The UIM card is applicable to a Code Division Multiple Access (CDMA) system. Like a SIM card, the UIM card is a security mechanism that helps the subscriber use the CDMA network simply and securely. Likewise, the prerequisite to the use of the CDMA network is that the subscriber has opened an account in the CDMA network.

An International Mobile Subscriber Identity (IMSI) is a special 15-digit number attached to each subscriber card. The IMSI makes it easy to identify the manufacturing country and the subscriber network in a mobile network.

To put it simply, a Mobile Station International Integrated Services Digital Network Number (MSISDN) needs to be bound to an IMSI before being usable in the GSM network.

All the prepaid service cards provided by mobile operators in the conventional art bind the IMSIs of prepaid subscribers to MSISDNs. That is, the SIM/UIM card purchased by a prepaid subscriber from the business hall or agent of an operator has specified an MSISDN as a prepaid subscriber number. As shown in FIG. 1, the Business and Operation Support System (BOSS) provides number resource management and generates card-making information based on the IMSIs and MSISDNs available for allocation; the card-issuing center makes cards according to the card-making information and allocates the cards to business halls and agents; accounts are opened for subscribers at the subscriber data center. The data center stores the static data of mobile prepaid subscribers, including mobile prepaid subscriber identification numbers, data related to access functions, prepaid subscriber types, and data related to supplementary service functions. The data center is generally set on a Home Location Register (HLR). The following description supposes that the data center is set on an HLR. The BOSS may also need to open accounts for intelligent network service control with a Service Control Point (SCP). The SCP stores data of intelligent network prepaid subscribers and the relevant service data.

In the conventional art, before sending a card-making order to the card-issuing center, the BOSS needs to finish opening accounts in batches on the HLR, pre-store the prepaid subscriber information such as IMSI, MSISDN (bound to the IMSI), and intelligent subscription information on the HLR, and activate the supplementary service. For certain services, the BOSS also needs to finish opening accounts in batches on the SCP, for example, specify the service feature information correlated with the MSISDNs of prepaid subscribers. Such information includes the corresponding brand, package, and other intelligent service feature requirements. After the BOSS finishes opening accounts, the BOSS activates the prepaid subscriber numbers according to the account opening success response returned by the HLR and SCP, registers the default service information (brand, package, and region) of prepaid subscribers, and then sends the card-making order to the card-issuing center. The card-issuing center generates SIM cards which contain data such as IMSI. The card-issuing center packs the SIM cards, MSISDNs and relevant service subscription information into suite cards, and allocates the cards to business halls or agents of the operator for marketing.

### SUMMARY OF THE INVENTION

Embodiments of the present invention provide a system, device, terminal and method for selecting numbers and opening accounts for prepaid subscribers so as to facilitate prepaid subscribers to select numbers and open accounts.

A system for selecting numbers and opening accounts for prepaid subscribers includes: a resource database adapted to store a list of candidate MSISDNs of prepaid subscribers, and at least one device for selecting numbers and opening accounts for prepaid subscribers, wherein:

the resource database is adapted to store a list of candidate Mobile Station International Integrated Services Digital Network Numbers (MSISDNs) of prepaid subscribers; and

the device for selecting numbers and opening accounts for prepaid subscribers is adapted to receive a number selection request from a prepaid subscriber, obtain the list of candidate MSISDNs of prepaid subscribers from the resource database according to the number selection request, and present the list of candidate MSISDNs to the prepaid subscriber who sends the number selection request; and receive an account opening request from the prepaid subscriber, wherein the request carries an International Mobile Subscriber Identity (IMSI) and an MSISDN of the prepaid subscriber, and the MSISDN of the prepaid subscriber is selected by the prepaid subscriber from the list of candidate MSISDNs; and open an account for the prepaid subscriber according to the IMSI and MSISDN of the prepaid subscriber.

At least one terminal for selecting numbers and opening accounts for prepaid subscribers includes:

a number selection requesting unit, adapted to receive a number selection request from a prepaid subscriber and forward the request to the device for selecting numbers and opening accounts, and receive a list of candidate MSISDNs of prepaid subscribers returned by the device for selecting numbers and opening accounts in response to the number selection request;

a second displaying unit, adapted to display the list of candidate MSISDNs of prepaid subscribers received by the number selection requesting unit; and

an account opening requesting unit, adapted to receive the MSISDN selected by the prepaid subscriber from the list of candidate MSISDNs, and the IMSI input by the prepaid subscriber, generate an account opening request that carries the IMSI and MSISDN of the prepaid subscriber, and send the account opening request to the device for selecting numbers and opening accounts.

The device for selecting numbers and opening accounts further includes: a first responding unit, adapted to generate a prepaid subscriber account opening response according to the account opening result of the account opening unit, and send the response to the terminal for selecting numbers and opening accounts.

The terminal for selecting numbers and opening accounts further includes: a third receiving unit, adapted to receive the prepaid subscriber account opening response, and display the response through the first displaying unit.

Further, the device for selecting numbers and opening accounts includes: a first displaying unit, adapted to display the list of candidate MSISDNs obtained by the number selecting unit; and a first updating unit, adapted to update the list of candidate MSISDNs stored in the resource database according to the MSISDN selected by the prepaid subscriber.

A method for selecting numbers and opening accounts for prepaid subscribers includes:

receiving a number selection request from a prepaid subscriber, and presenting a list of candidate MSISDNs of prepaid subscribers to the prepaid subscriber who sends the number selection request;

receiving an account opening request from the prepaid subscriber, where the request carries an IMSI and an MSISDN of the prepaid subscriber, and the MSISDN of the prepaid subscriber is selected by the prepaid subscriber from the list of candidate MSISDNs; and

opening an account for the prepaid subscriber according to the IMSI and MSISDN of the prepaid subscriber.

The technical solution to selecting numbers and opening accounts for prepaid subscribers herein separates IMSIs from MSISDNs, and the BOSS does not need to pre-store the data of prepaid subscribers on the relevant network devices, thus reducing occupation of equipment resources and costs of network operation and improving equipment performance. Accordingly, at the time of taking back the unsold prepaid numbers, it is not necessary to delete the pre-stored information, which also reduces the cost of reclaiming numbers. In addition, a prepaid subscriber may select any unused number available from the operator in the region freely, thus improving the utilization of numbers. In the number selection, the brand and tariff plan may be set flexibly, thus providing a better user experience.

### BRIEF DESCRIPTION OF THE DRAWINGS

FIG. 1 shows the operation of opening an account for a prepaid subscriber in the conventional art;

FIG. 2 shows a structure of a system for selecting numbers and opening accounts for prepaid subscribers according to an embodiment of the present invention;

FIG. 3 is a flowchart of selecting numbers and opening accounts for prepaid subscribers through USSD according to an embodiment of the present invention;

FIG. 4 is a flowchart of selecting numbers and opening accounts for prepaid subscribers through Portal according to an embodiment of the present invention;

FIG. 5a, FIG. 5b and FIG. 6 show structures of a device for selecting numbers and opening accounts for prepaid subscribers according to an embodiment of the present invention;

FIG. 7 shows a structure of a terminal for selecting numbers and opening accounts for prepaid subscribers according to an embodiment of the present invention; and

FIG. 8 is a flowchart of a method for selecting numbers and opening accounts for prepaid subscribers according to an embodiment of the present invention.

### DETAILED DESCRIPTION OF THE INVENTION

In the conventional art, the number resources are not shared in the sale of prepaid subscriber numbers, each point of sale sells limited physical cards, and the prepaid subscribers are unable to select numbers freely. Moreover, before the prepaid subscribers purchase SIM cards in the conventional art, the IMSI and MSISDN resources have been allocated, activated, and bound, and the relevant prepaid subscriber data has been stored on the HLR and SCP, thus occupying the storage space of the HLR and SCP, affecting the performance of the HLR and SCP and increasing the equipment cost. If the prepaid subscriber numbers are ultimately unused, the pre-stored prepaid subscriber data needs to be deleted from the HLR and SCP, thus making the reclaiming of numbers complicated, and increasing the cost of number reclaiming.

To solve the problems caused by the binding between the prepaid subscriber IMSI and the MSISDN in a prepaid service card, an embodiment of the present invention proposes a conception of separating the IMSI from the MSISDN. That is, the subscriber card (such as SIM) purchased by the subscriber is not bound to the MSISDN, and the IMSI is written into the subscriber card; through the business terminal of the operator or the device of the agent, the subscriber may select a number, subscribe to the services such as a brand and package, and open an account. A device for selecting numbers and opening accounts is added in the embodiment of the present invention. The device for selecting numbers and opening accounts is connected to the BOSS, subscriber data center, and SCP, and is adapted to receive and handle the request for selecting an unallocated MSISDN from the prepaid subscriber who purchases a subscriber card unbound to the MSISDN, and open an account for the prepaid subscriber on the relevant network entities according to the subscriber request. Further, a terminal for selecting numbers and opening accounts may be added, and connected to the device for selecting numbers and opening accounts through Unstructured Supplementary Service Data (USSD), Short Message Service (SMS) or Portal. The terminal for selecting numbers and opening accounts may be set at each point of sale flexibly to facilitate user operations.

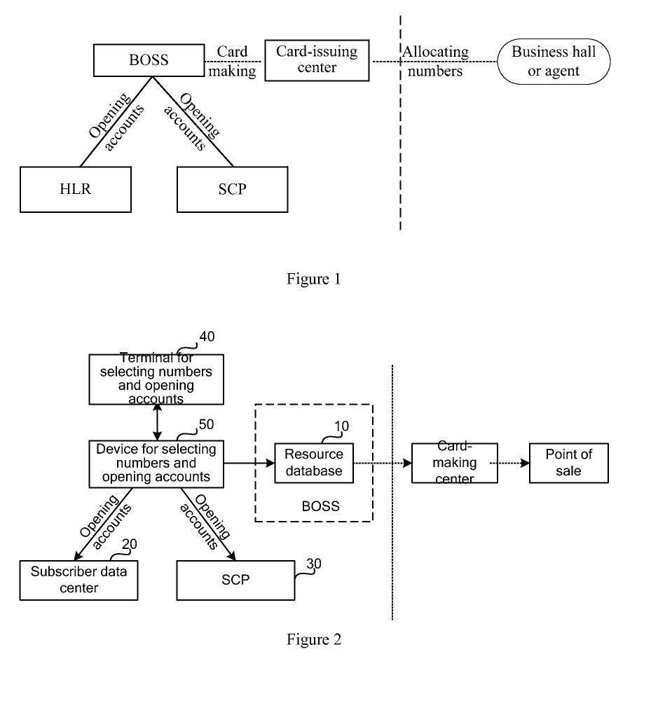

As shown in FIG. 2, for the purpose of implementing the foregoing technical conception, a system for selecting numbers and opening accounts for prepaid subscribers is provided in an embodiment of the present invention. The system includes a resource database 10, a subscriber data center 20, an intelligent network SCP 30, at least one terminal 40 for selecting numbers and opening accounts for prepaid subscribers, and at least one device 50 for selecting numbers and opening accounts for prepaid subscribers.

The resource database 10 is adapted to store the list of candidate MSISDNs of prepaid subscribers. The resource database is generally set in the BOSS, and the list of candidate MSISDNs is composed of the prepaid subscriber MSISDNs available for allocation. According to an allocated prepaid subscriber IMSI, the BOSS generates a card-making order, and sends the card-making order to the card-making center. The card-making center makes a subscriber card that carries the IMSI information. The IMSI information may be a true IMSI, or code information (for example, a card number) corresponding to the true IMSI.

The subscriber data center 20 is adapted to register the IMSI and MSISDN of the prepaid subscriber. For each prepaid subscriber, the IMSI is bound to the MSISDN. Depending on the specific system, the subscriber data center may be set on the corresponding network entity or on an opposite location. For example, in the GSM system, the subscriber data center 20 may be set on the HLR, and the HLR registers the services such as telephone, Short Message Service (SMS), USSD, and General Packet Radio Service (GPRS) for the subscriber according to the binding relation between the IMSI and the MSISDN.

The intelligent network SCP 30 is adapted to activate the relevant intelligent network service features selected by the prepaid subscriber according to the service feature information correlated with the registered prepaid subscriber MSISDN, and set the information such as brand and tariff plan correctly.

The terminal 40 for selecting numbers and opening accounts for prepaid subscribers is adapted to receive a number selection request from the prepaid subscriber, and forward the request to the device 50 for selecting numbers and opening accounts; the device 50 for selecting numbers and opening accounts is adapted to obtain a list of candidate MSISDNs of prepaid subscribers from the resource database 10 after receiving the number selection request from the prepaid subscriber, and send the list to the terminal 40 for selecting numbers and opening accounts. The terminal 40 for selecting numbers and opening accounts displays the list of candidate MSISDNs to the prepaid subscriber, and the subscriber selects an MSISDN from the list and sends an account opening request, and then inputs an IMSI on the interface provided by the terminal 40 for selecting numbers and opening accounts. The terminal 40 for selecting numbers and opening accounts automatically generates an account opening request and sends the request to the device 50 for selecting numbers and opening accounts. The account opening request carries the IMSI input by the prepaid subscriber and the MSISDN selected by the prepaid subscriber. After receiving the account opening request of the prepaid subscriber, the device 40 for selecting numbers and opening accounts opens an account for the prepaid subscriber according to the IMSI and MSISDN of the prepaid subscriber.

If the IMSI of the prepaid subscriber is the true IMSI of the prepaid subscriber, the device 40 for selecting numbers and opening accounts opens an account according to the true IMSI directly. Conversely, if the IMSI of the prepaid subscriber is code information corresponding to the true IMSI, a mapping relation table between the code information and the true IMSI needs to be obtained beforehand. The device 40 for selecting numbers and opening accounts 40 searches the mapping relation table for the true IMSI corresponding to the code information.

The operation of opening an account includes at least registering the IMSI and MSISDN of the prepaid subscriber with the subscriber data center 20, and identifying that the IMSI and MSISDN are in use. For each prepaid subscriber, the IMSI is bound to the MSISDN.

For certain intelligent network services, the operation of opening an account further includes registering the service feature information correlated with the MSISDN of the prepaid subscriber with the intelligent network SCP 30.

After the operation of opening an account is completed, the subscriber data center 20 and the SCP 30 may return an account opening success response to the device 40 for selecting numbers and opening accounts respectively. After receiving the response, the device 40 for selecting numbers and opening accounts sets the MSISDN to the “used” state, updates the resource database 10, registers the service subscription information such as brand and tariff plan selected by the subscriber with the BOSS, and returns an account opening success response to the subscriber, whereupon the subscriber MSISDN is activated.

Alternatively, the number selection and account opening may be performed at the local region of the device 40 for selecting numbers and opening accounts.

The technical solution of the present invention is hereinafter described in detail with reference to the embodiments.

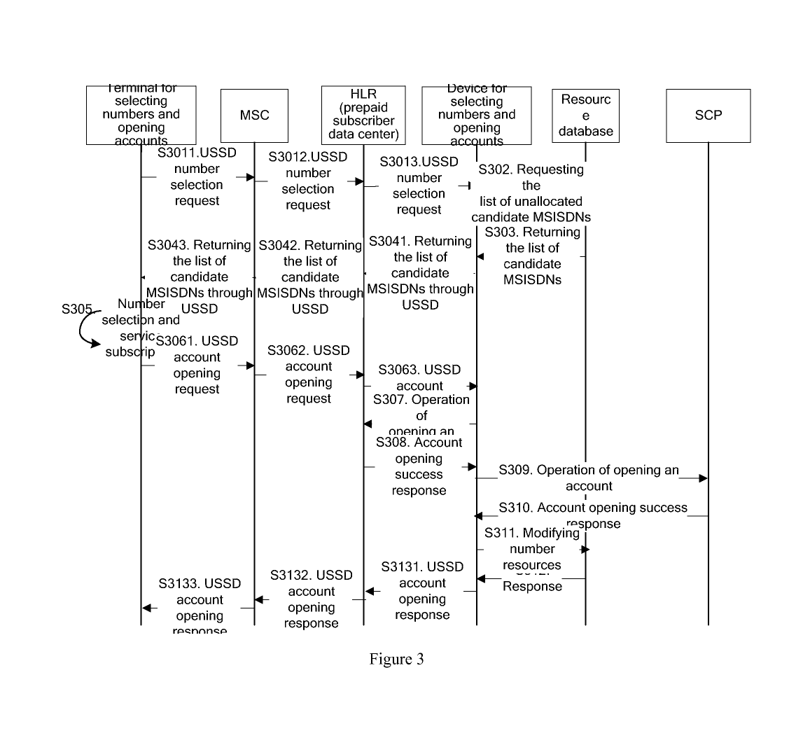

As shown in FIG. 3, a radio connection is set up between the terminal for selecting numbers and opening accounts and the device for selecting numbers and opening accounts through a Mobile Switching Center (MSC) and an HLR for communication through USSD. The process of selecting a number and opening an account for a prepaid subscriber includes the following steps:

Steps S3011-S3013: After purchasing a subscriber card that carries only the IMSI information, the prepaid subscriber sends a USSD number selection request to the device for selecting numbers and opening accounts via the terminal for selecting numbers and opening accounts placed at the business hall or agent of the operator, and queries the candidate MSISDNs unallocated in the region of the prepaid subscriber. The USSD number selection request is transparently transmitted to the device for selecting numbers and opening accounts through the MSC and HLR.

Steps S302-S303: The device for selecting numbers and opening accounts obtains the list of candidate MSISDNs from the resource database in the BOSS.

Steps S3041-S3043: The device for selecting numbers and opening accounts returns the obtained list of candidate MSISDNs to the terminal for selecting numbers and opening accounts through USSD.

According to the operation policy, the list of candidate MSISDNs may include part of the unallocated MSISDNs, for example, only 5 to 10 numbers are available to the subscriber for selection at a time.

Step S305: The prepaid subscriber selects an MSISDN, a brand, a tariff plan, and other basic service features, and then sends a USSD account opening request through the interface provided by the terminal for selecting numbers and opening accounts. The USSD account opening request carries the IMSI input by the prepaid subscriber and the MSISDN selected by the prepaid subscriber.

Steps S3061-S3063: The USSD account opening request is transparently transmitted to the device for selecting numbers and opening accounts through the MSC and HLR.

Step S307-S310: After receiving the USSD account opening request, the device for selecting numbers and opening accounts opens an account for the prepaid subscriber with the subscriber data center on the HLR and the SCP in the intelligent network respectively; specifically: the device registers the IMSI and MSISDN of the prepaid subscriber with the subscriber data center, and registers the service feature information correlated with the MSISDN of the prepaid subscriber with the intelligent network SCP; and the HLR and SCP return an account opening success response respectively after the account is opened successfully.

Steps S311-S312: After receiving the account opening success response from the HLR and SCP, the device for selecting numbers and opening accounts marks the MSISDN selected by the subscriber as “used”, registers the service subscription information such as brand and tariff plan selected by the subscriber with the BOSS system, and updates the list of candidate MSISDNs in the resource database to modify the number resource information. The update operation may be performed by the device for selecting numbers and opening accounts directly, or the device for selecting numbers and opening accounts sends the MSISDN selected by the subscriber to the BOSS and the BOSS performs the update.

Steps S3131-S3133: The device for selecting numbers and opening accounts returns an account opening response to the terminal for selecting numbers and opening accounts.

The terminal for selecting numbers and opening accounts displays the account opening response to the prepaid subscriber who requests to open the account. The process of selecting a number and opening an account is complete, and the MSISDN selected by the subscriber is activated.

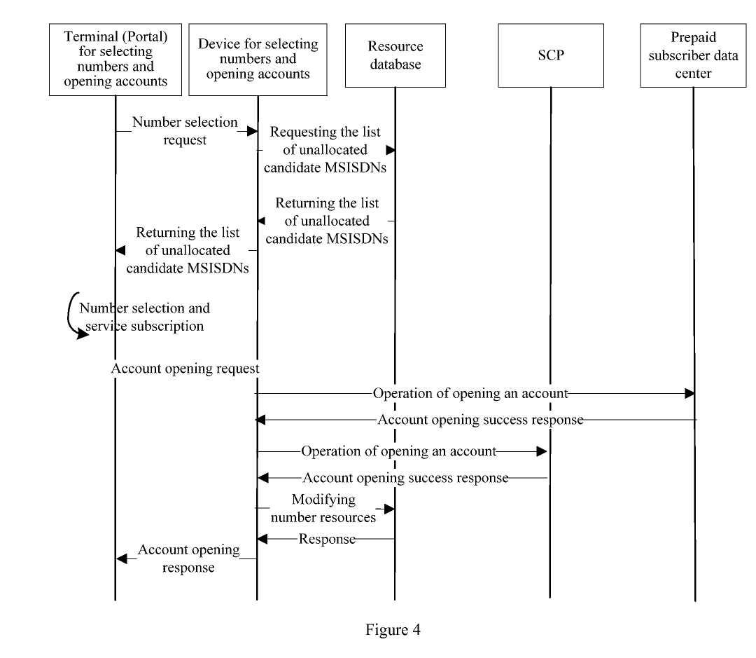

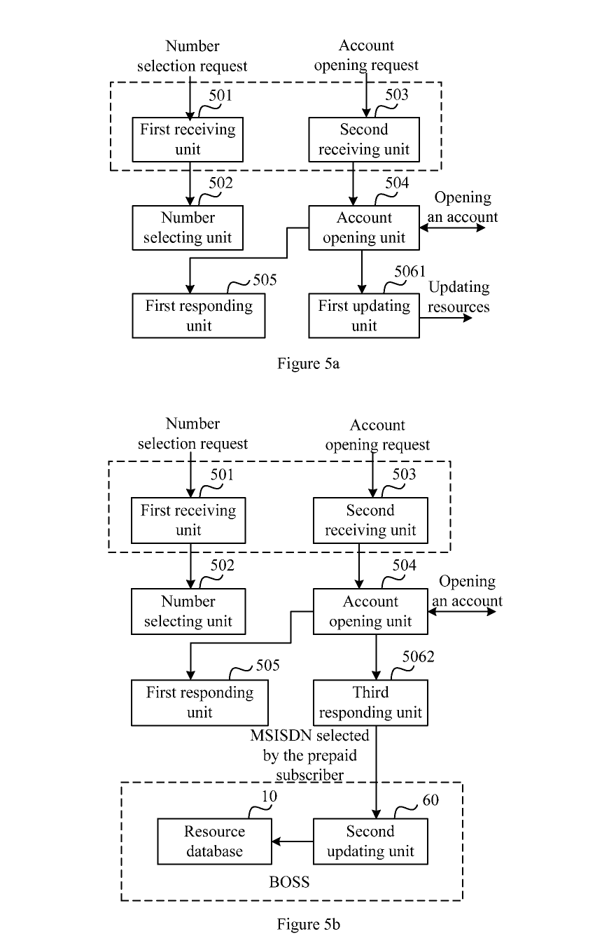

As shown in FIG. 4, the terminal for selecting numbers and opening accounts is connected to the device for selecting numbers and opening accounts directly through the Internet. The terminal for selecting numbers and opening accounts is a Portal server. The process is the same as the process shown in FIG. 3 except the communication mode between the terminal for selecting numbers and opening accounts and the device for selecting numbers and opening accounts, and is not detailed here further.

Besides, the terminal for selecting numbers and opening accounts may communicate with the device for selecting numbers and opening accounts through SMS, which is similar to the process shown in FIG. 3 and not repeated further.

As shown in FIG. 5a, a structure of a device for selecting numbers and opening accounts in an embodiment of the present invention includes:

a first receiving unit 501, adapted to receive a number selection request of a prepaid subscriber from a terminal for selecting numbers and opening accounts;

a number selecting unit 502, adapted to: obtain the list of candidate MSISDNs of prepaid subscribers from the resource database in the BOSS according to the number selection request of the prepaid subscriber, and forward the list of candidate MSISDNs to the terminal for selecting numbers and opening accounts, whereupon the terminal for selecting numbers and opening accounts presents the list to the prepaid subscriber who sends the number selection request through a display interface;

a second receiving unit 503, adapted to: receive an account opening request of the prepaid subscriber from the terminal for selecting numbers and opening accounts, where the request carries an IMSI and an MSISDN of the prepaid subscriber, and the MSISDN of the prepaid subscriber is selected by the prepaid subscriber from the list of candidate MSISDNs;

an account opening unit 504, adapted to open an account for the prepaid subscriber according to the IMSI and MSISDN of the prepaid subscriber, and receive the returned account opening success response;

a first responding unit 505, adapted to: generate a prepaid subscriber account opening response according to the account opening result of the account opening unit after receiving the account opening success response, and send the response to the terminal for selecting numbers and opening accounts; and

a first updating unit 5061, adapted to update the MSISDN selected by the prepaid subscriber and included in the list of candidate MSISDNs stored in the resource database 10 according to the MSISDN selected by the prepaid subscriber after the account is opened successfully, with a view to updating the number resources.

As shown in FIG. 5b, the device for selecting numbers and opening accounts in another embodiment of the present invention does not update the resource database 10 directly, but sends the MSISDN selected by the prepaid subscriber to the second updating unit 60 in the BOSS in place of the third responding unit 5062 of the first updating unit 5061. After receiving the MSISDN information from the third responding unit 5062, the second updating unit 60 updates the list of candidate MSISDNs stored in the resource database 10. The update may be performed by deleting or adding a corresponding flag.

As shown in FIG. 6, to select a number and open an account for the prepaid subscriber through the device for selecting numbers and opening accounts, the device for selecting numbers and opening accounts in another embodiment of the present invention not only includes the structure shown in FIG. 5a, but also includes a first displaying unit 507 and a second responding unit 508.

The first displaying unit 507 is adapted to display the list of candidate MSISDNs obtained by the number selecting unit. The first displaying unit 507 may be connected to the second receiving unit 503 for internal communication. After the subscriber selects an MSISDN, the first displaying unit 507 triggers the process of account opening request directly, prompts the user to input the IMSI through an interface, and then generates an account opening request and sends the request to the account opening unit 504.

The second responding unit 508 is adapted to generate a prepaid subscriber account opening response according to the account opening result of the account opening unit, and display the response through the first displaying unit.

If the account opening request of the subscriber comes from the terminal for selecting numbers and opening accounts, the account opening unit 504 triggers the first responding unit 505 after the account is opened successfully. If the account opening request of the subscriber comes from a local device, the account opening unit 504 triggers the second responding unit 508 after the account is opened successfully.

The implementation principle on the basis of FIG. 5b is the same, and not repeated further.

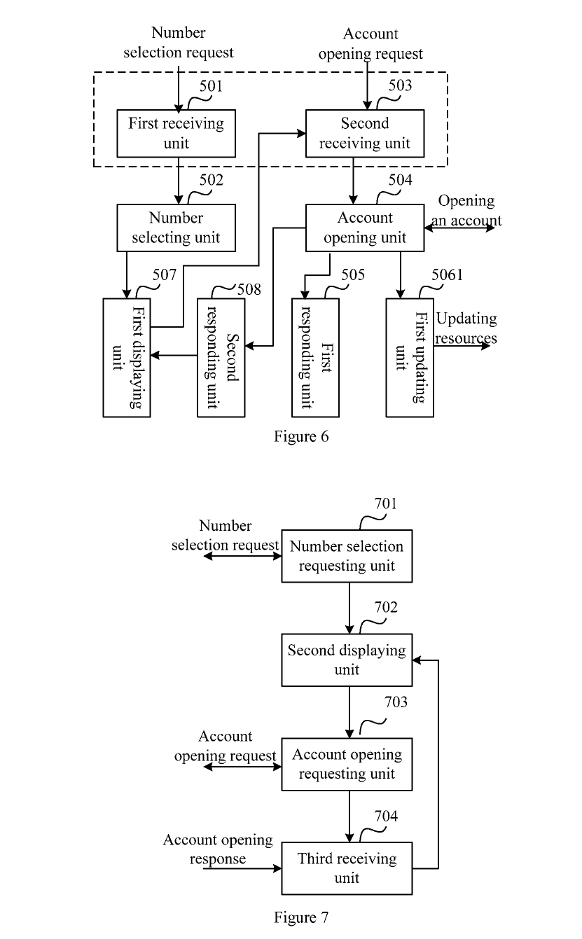

FIG. 7 shows a terminal for selecting numbers and opening accounts for prepaid subscribers in an embodiment of the present invention. The terminal includes:

a number selection requesting unit 701, adapted to: receive a number selection request from a prepaid subscriber and forward the request to a device for selecting numbers and opening accounts, and receive the list of candidate MSISDNs of prepaid subscribers returned by the device for selecting numbers and opening accounts in response to the number selection request;

a second displaying unit 702, adapted to display the list of candidate MSISDNs of prepaid subscribers received by the number selection requesting unit;

an account opening requesting unit 703, adapted to: receive the MSISDN selected by the prepaid subscriber from the list of candidate MSISDNs, and the IMSI input by the prepaid subscriber, and generate and send an account opening request that carries the IMSI and MSISDN of the prepaid subscriber; and

a third receiving unit 704, adapted to: receive the prepaid subscriber account opening response returned in response to the account opening request, and display the response through the second displaying unit 702.

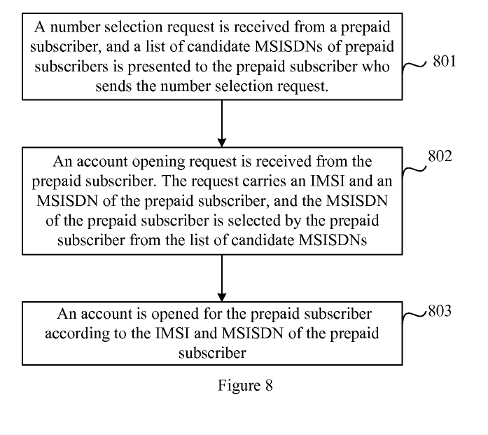

In summary, as shown in FIG. 8, the method for selecting numbers and opening accounts for prepaid subscribers in an embodiment of the present invention includes the following steps:

block 801: A number selection request is received from a prepaid subscriber, and a list of candidate MSISDNs of prepaid subscribers is presented to the prepaid subscriber who sends the number selection request.

block 802: An account opening request is received from the prepaid subscriber. The request carries an IMSI and an MSISDN of the prepaid subscriber, and the MSISDN of the prepaid subscriber is selected by the prepaid subscriber from the list of candidate MSISDNs; and

block 803: An account is opened for the prepaid subscriber according to the IMSI and MSISDN of the prepaid subscriber.

The operation of opening an account includes registering the IMSI and MSISDN of the prepaid subscriber with the subscriber data center.

The operation of opening an account may further include registering the service feature information correlated with the MSISDN of the prepaid subscriber with the SCP.

Therefore, the technical solution to selecting numbers and opening accounts for prepaid subscribers in embodiments of the present invention separates the IMSI from the MSISDN. The prepaid subscriber selects a number and opens an account through a terminal and device for selecting numbers and opening accounts. The device for selecting numbers and opening accounts opens an account for the prepaid subscriber only after the subscriber selects an MSISDN, and registers the subscriber data with the relevant network entities. It is not necessary to pre-store the data of the prepaid subscriber on the relevant network devices, thus reducing occupation of equipment resources and costs of network operation and improving equipment performance.

Accordingly, at the time of taking back the unsold prepaid numbers, it is not necessary to delete the pre-stored information, which also reduces the cost of reclaiming numbers. In addition, the prepaid subscriber may select any unused number available from the operator in the region freely, thus improving the utilization of numbers. In the number selection, the brand and tariff plan may be set flexibly, thus providing a better user experience.

Although the present invention has been described through some exemplary embodiments, the invention is not limited to such embodiments. It is apparent that those skilled in the art can make various modifications and variations to the invention without departing from the spirit and scope of the invention. The invention is intended to cover these modifications and variations provided that they fall in the scope of protection defined by the following claims or their equivalents.

1. A system for selecting numbers and opening accounts for prepaid subscribers, comprising:
a resource database, adapted to store a list of candidate Mobile Station International Integrated Services Digital Network Numbers (MSISDNs) of prepaid subscribers; and
at least one device for selecting numbers and opening accounts for prepaid subscribers, adapted to receive a number selection request from a prepaid subscriber, obtain the list of candidate MSISDNs of prepaid subscribers from the resource database according to the number selection request, and present the list of candidate MSISDNs to the prepaid subscriber who sends the number selection request;
wherein the device for selecting numbers and opening accounts for prepaid subscribers is further adapted to receive an account opening request from the prepaid subscriber, wherein the request carries an International Mobile Subscriber Identity (IMSI) and an MSISDN of the prepaid subscriber, and the MSISDN of the prepaid subscriber is selected by the prepaid subscriber from the list of candidate MSISDNs; and open an account for the prepaid subscriber according to the IMSI and MSISDN of the prepaid subscriber.

2. The system of claim 1, further comprising at least one terminal for selecting numbers and opening accounts for prepaid subscribers, wherein the terminal for selecting numbers and opening accounts is adapted to receive the number selection request from the prepaid subscriber and forward the request to the device for selecting numbers and opening accounts, and receive the list of candidate MSISDNs of prepaid subscribers returned by the device for selecting numbers and opening accounts in response to the number selection request; and display the list of candidate MSISDNs of prepaid subscribers received by the number selection requesting unit; and receive the MSISDN selected by the prepaid subscriber from the list of candidate MSISDNs, and the IMSI input by the prepaid subscriber, generate an account opening request that carries the IMSI and MSISDN of the prepaid subscriber, and send the account opening request to the device for selecting numbers and opening accounts.

3. The system of claim 2, wherein:
the device for selecting numbers and opening accounts is further adapted to generate a prepaid subscriber account opening response according to an account opening result, and send the response to the terminal for selecting numbers and opening accounts; and
the terminal for selecting numbers and opening accounts is further adapted to receive the prepaid subscriber account opening response.

4. The system of claim 1, wherein the device for selecting numbers and opening accounts is further adapted to display the list of candidate MSISDNs obtained by the number selecting unit.

5. The system of claim 1, wherein the device for selecting numbers and opening accounts is further adapted to update the list of candidate MSISDNs stored in the resource database according to the MSISDN selected by the prepaid subscriber.

6. The system of claim 1, wherein the device for selecting numbers and opening accounts is further adapted to send the MSISDN selected by the prepaid subscriber; and
wherein the system further comprises a second updating unit, adapted to receive the MSISDN sent by the device for selecting numbers and opening accounts, and update the list of candidate MSISDNs stored in the resource database.

7. The system of claim 1, further comprising a subscriber data center, adapted to register the IMSI and MSISDN of the prepaid subscriber when the account opening unit opens an account for the prepaid subscriber, wherein the IMSI of the prepaid subscriber is bound to the MSISDN of the prepaid subscriber.

8. The system of claim 1, further comprising at least one Service Control Point (SCP) adapted to register the service feature information correlated with the MSISDN of the prepaid subscriber when the account opening unit opens an account for the prepaid subscriber.

9. A device for selecting numbers and opening accounts for prepaid subscribers, comprising:
a first receiving unit, adapted to receive a number selection request from a prepaid subscriber;
a number selecting unit, adapted to obtain a list of candidate Mobile Station International Integrated Services Digital Network Numbers (MSISDNs) of prepaid subscribers according to the number selection request, and present the list of candidate MSISDNs to the prepaid subscriber who sends the number selection request;
a second receiving unit, adapted to receive an account opening request from the prepaid subscriber, wherein the request carries an International Mobile Subscriber Identity (IMSI) and an MSISDN of the prepaid subscriber, and the MSISDN of the prepaid subscriber is selected by the prepaid subscriber from the list of candidate MSISDNs; and
an account opening unit, adapted to open an account for the prepaid subscriber according to the IMSI and MSISDN of the prepaid subscriber.

10. The device of claim 9, further comprising: a first displaying unit, adapted to display the list of candidate MSISDNs obtained by the number selecting unit.

11. The device of claim 10, further comprising: a first responding unit, adapted to generate a prepaid subscriber account opening response according to an account opening result of the account opening unit, and send the response.

12. The device of claim 10, further comprising:
a first updating unit, adapted to update the list of candidate MSISDNs stored in a resource database according to the MSISDN selected by the prepaid subscriber; or
a third responding unit, adapted to send the MSISDN selected by the prepaid subscriber.

13. A terminal for selecting numbers and opening accounts for prepaid subscribers, comprising:
a number selection requesting unit, adapted to receive a number selection request from a prepaid subscriber and forward the request, and receive a list of candidate Mobile Station International Integrated Services Digital Network Numbers (MSISDNs) of prepaid subscribers returned in response to the number selection request;
a second displaying unit, adapted to display the list of candidate MSISDNs of prepaid subscribers received by the number selection requesting unit; and
an account opening requesting unit, adapted to receive an MSISDN selected by the prepaid subscriber from the list of candidate MSISDNs, and an International Mobile Subscriber Identity (IMSI) input by the prepaid subscriber, and generate and send an account opening request carrying the IMSI and MSISDN of the prepaid subscriber.

14. The terminal of claim 13, further comprising: a third receiving unit, adapted to receive a prepaid subscriber account opening response returned in response to the account opening request, and display the response through the second displaying unit.

15. A method for selecting numbers and opening accounts for prepaid subscribers, comprising:
receiving a number selection request from a prepaid subscriber, and presenting a list of candidate Mobile Station International Integrated Services Digital Network Numbers (MSISDNs) of prepaid subscribers to the prepaid subscriber who sends the number selection request;
receiving an account opening request from the prepaid subscriber, wherein the request carries an International Mobile Subscriber Identity (IMSI) and an MSISDN of the prepaid subscriber, and the MSISDN of the prepaid subscriber is selected by the prepaid subscriber from the list of candidate MSISDNs; and
opening an account for the prepaid subscriber according to the IMSI and MSISDN of the prepaid subscriber.

16. The method of claim 15, wherein the operation of opening an account comprises: registering the IMSI and MSISDN of the prepaid subscriber with the subscriber data center, wherein the IMSI of the prepaid subscriber is bound to the MSISDN of the prepaid subscriber.

17. The method of claim 15, wherein the operation of opening an account further comprises: registering service feature information correlated with the MSISDN of the prepaid subscriber with a Service Control Point (SCP).

18. A computer program product, comprising computer program code, which, when executed by a computer unit, will cause the computer unit to perform the steps of claim 15.

19. The computer program product of claim 18, wherein the computer program code is included in computer readable medium.
